(19) United States
(12) Patent Application Publication
(10) Pub. No.: US 2019/0163221 A1
(43) Pub. Date: May 30, 2019

(54) SEMICONDUCTOR DEVICE AND CURRENT ADJUSTMENT METHOD IN SEMICONDUCTOR DEVICE

(71) Applicant: RENESAS ELECTRONICS CORPORATION, Tokyo (JP)

(72) Inventors: Sachiko NISHINO, Tokyo (JP); Masashi HIRANO, Tokyo (JP); Seiji KOBAYASHI, Tokyo (JP)

(21) Appl. No.: 16/136,013

(22) Filed: Sep. 19, 2018

(30) Foreign Application Priority Data
Nov. 28, 2017 (JP) 2017-227919

(51) Int. Cl. G05F 1/595; H02H 5/04

(52) U.S. Cl. CPC G05F 1/595; H02H 5/041

(57) ABSTRACT

There is provided a semiconductor device capable of equalizing a chip temperature while suppressing variation in electrical stress applied to each circuit at the time of a burn-in test. A semiconductor device according to one embodiment includes a current adjustment circuit capable of adjusting a current amount flowing in the current adjustment circuit itself, a flash memory for storing an adjustment amount of the current adjustment circuit, and a control circuit for controlling the current amount flowing in the current adjustment circuit in accordance with the adjustment amount when a burn-in mode signal indicating a burn-in mode is supplied.

### CROSS-REFERENCE TO RELATED APPLICATIONS

The disclosure of Japanese Patent Application No. 2017-227919 filed on Nov. 28, 2017 including the specification, drawings and abstract is incorporated herein by reference in its entirety.

### BACKGROUND

The present invention relates to a semiconductor device and a current adjustment method in the semiconductor device, and more particularly, to a semiconductor device on which a burn-in test is performed and a current adjustment method in the semiconductor device.

In recent years, semiconductor devices have been widely used also in products requiring reliability such as on-vehicle products, and further improvement in reliability of such a semiconductor device has been becoming an important problem. In general, a screening test such as a burn-in test is performed on the semiconductor device before shipment to remove initial failure products. The burn-in test is one of the screening tests, and is a test that is a combination of a voltage acceleration test and a temperature acceleration test.

Japanese Unexamined Patent Publication No. 2013-29439 (Patent Document 1) discloses a technique related to the burn-in test of the semiconductor device. In the burn-in test disclosed in Patent Document 1, a proper frequency is set for each circuit included in the semiconductor device, thereby controlling the amount of heat generation of each circuit.

### SUMMARY

In the technique disclosed in Patent Document 1, a setting frequency is adjusted for each circuit included in the semiconductor device, thereby controlling the amount of heat generation of each circuit to equalize the temperature of the semiconductor devices.

However, since the method of adjusting the setting frequency for each circuit is an indirect method from the viewpoint of equalizing thermal stress, large stress is applied to a circuit with a high operating frequency, so that there is a problem that electrical stress applied to each circuit varies among circuits.

The other problems and novel features will become apparent from the description of this specification and the accompanying drawings.

A semiconductor device according to one embodiment includes a current adjustment circuit capable of adjusting a current amount flowing in the current adjustment circuit itself. A control circuit controls the current amount flowing in the current adjustment circuit in accordance with an adjustment amount stored in a storage circuit when a burn-in mode signal indicating a burn-in mode is supplied.

According to the one embodiment, it is possible to provide a semiconductor device capable of equalizing the chip temperature while suppressing variation in electrical stress applied to each circuit at the time of the burn-in test and a current adjustment method in the semiconductor device.

### BRIEF DESCRIPTION OF THE DRAWINGS

FIG. 1 is a diagram for explaining a semiconductor device according to a related art.

FIG. 2 is a graph showing a BI current and a chip temperature Tj in each power supply area of the semiconductor device according to the related art.

FIG. 3 is a diagram for explaining a semiconductor device according to a first embodiment.

FIG. 4 is a graph showing a BI current and a chip temperature Tj in each power supply area of the semiconductor device according to the first embodiment.

FIG. 5 is a block diagram showing a configuration example of the semiconductor device according to the first embodiment.

FIG. 6 is a block diagram showing a specific configuration example of the semiconductor device according to the first embodiment.

FIG. 7 is a table showing an example of the relationship between each power supply area and the chip temperature Tj in the semiconductor device according to the first embodiment.

FIG. 8 is a table showing an example of the relationship between a current adjustment amount and the chip temperature Tj in each power supply area of the semiconductor device according to the first embodiment.

FIG. 9 is a block diagram showing a configuration example of a semiconductor device according to a second embodiment.

FIG. 10 is a block diagram showing a specific configuration example of the semiconductor device according to the second embodiment.

FIG. 11 is a graph showing the progression of the chip temperature Tj with respect to time in the semiconductor device according to the second embodiment.

FIG. 12 is a graph showing the temperature Tj of each chip of a semiconductor device according to a third embodiment.

FIG. 13 is a diagram for explaining a semiconductor device according to a fourth embodiment.

FIG. 14 is a timing chart showing timing for passing a current in each power supply area of the semiconductor device according to the fourth embodiment.

FIG. 15 is a table showing an example of the relationship between a current value and the chip temperature Tj in each power supply area of a semiconductor device according to a fifth embodiment.

FIG. 16 is a table showing an example of the relationship between the current adjustment amount and the chip temperature Tj in each power supply area of the semiconductor device according to the fifth embodiment.

FIG. 17 is a diagram for explaining another configuration example of the semiconductor device according to the fifth embodiment.

### DETAILED DESCRIPTION

### Description of Related Art

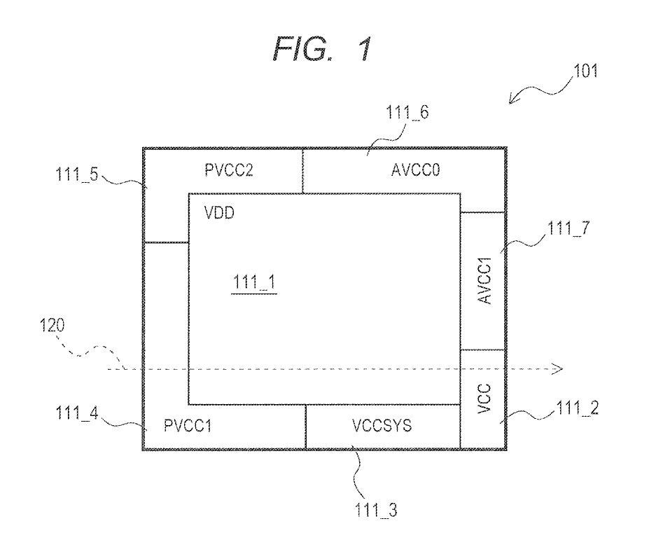

First, a related art will be described. FIG. 1 is a diagram for explaining a semiconductor device according to the related art. As shown in FIG. 1, the semiconductor device 101 according to the related art is a chip-shaped semiconductor device, and includes a plurality of circuit blocks 111_1 to 111_7. The circuit blocks 111_1 to 111_7 are circuit blocks divided into power supply areas coupled to power supply wiring lines different from each other.

In the example shown in FIG. 1, the circuit block 111_1 is a power supply area VDD, the circuit block 111_2 is a power supply area VCC, the circuit block 111_3 is a power supply area VCCSYS, the circuit block 111_4 is a power supply area PVCC1, the circuit block 111_5 is a power supply area PVCC2, the circuit block 111_6 is a power supply area AVCC0, and the circuit block 111_7 is a power supply area AVCC1. Hereinafter, the circuit blocks 111_1 to 111_7 are described as the power supply areas 111_1 to 111_7.

When a burn-in test is performed on the semiconductor device 101, the semiconductor device 101 is set on a burn-in board (not shown) for the burn-in test. Then, an ambient temperature Ta of the semiconductor device 101 is set to a predetermined temperature, and a program for the burn-in test is executed, thereby passing a predetermined current in each power supply area 111_1 to 111_7 of the semiconductor device 101. Thereby, a temperature acceleration test and a voltage acceleration test are performed on the semiconductor device 101, and it is possible to verify the presence or absence of an initial failure of the semiconductor device 101.

Thus, when the burn-in test is performed on the semiconductor device 101, a burn-in current (BI current) for the burn-in test is passed in each power supply area 111_1 to 111_7 of the semiconductor device 101. However, current amounts flowing in the power supply areas 111_1 to 111_7 of the semiconductor device 101 are different from each other; therefore, even if the ambient temperature Ta at the time of the burn-in test is constant, a chip temperature Tj varies among the power supply areas 111_1 to 111_7 of the semiconductor device 101.

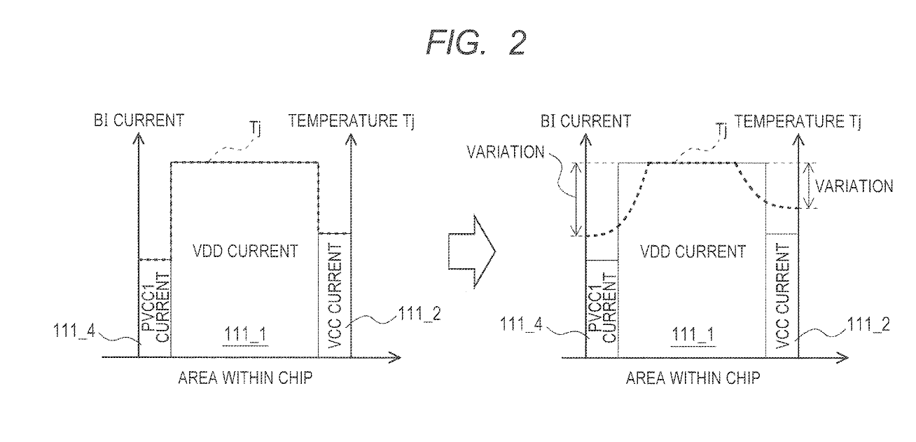

FIG. 2 is a graph showing the BI current and the chip temperature Tj in each power supply area 111_1 to 111_7 of the semiconductor device 101 according to the related art. FIG. 2 shows the BI current and the chip temperature Tj in the area within the chip in the direction of an arrow 120 in FIG. 1 as an example.

As shown in the left graph in FIG. 2, the BI current amounts flowing in the power supply area PVCC1 (111_4), the power supply area VDD (111_1), and the power supply area VCC (111_2) at the time of the burn-in test are different from each other. In the example shown in FIG. 2, the BI current amount flowing in the power supply area VDD (111_1) is the largest, the BI current amount flowing in the power supply area VCC (111_2) is the second largest, and the BI current amount flowing in the power supply area PVCC1 (111_4) is the smallest.

The chip temperature of each power supply area 111_1, 111_2, 111_4 increases as the BI current amount flowing in each power supply area 111_1, 111_2, 111_4 increases. Therefore, among the chip temperatures Tj (shown by a broken line) of the power supply areas 111_1, 111_2, 111_4, the chip temperature of the power supply area 111_1 is the highest, the chip temperature of the power supply area 111_2 is the second highest, and the chip temperature of the power supply area 111_4 is the lowest.

In this case, since the BI current amount is constant in each power supply area 111_1, 111_2, 111_4, the chip temperature Tj is constant in each power supply area 111_1, 111_2, 111_4. That is, as shown in the left graph in FIG. 2, the BI current amount and the chip temperature Tj discontinuously change at the boundaries of the power supply areas 111_1, 111_2, 111_4.

However, in reality, since heat propagation occurs among the power supply areas 111_1, 111_2, 111_4, the power supply areas 111_1, 111_2, 111_4 are affected by each other. Therefore, the chip temperatures Tj of the power supply areas 111_1, 111_2, 111_4 are continuously distributed as shown in the right graph in FIG. 2. That is, the chip temperatures Tj of the power supply areas 111_4 and 111_2 rise under the influence of the power supply area 111_1 whose chip temperature Tj is higher than those of the power supply areas 111_4, 111_2.

Thus, in the semiconductor device 101 according to the related art, the current amounts flowing in the power supply areas 111_1 to 111_7 of the semiconductor device 101 are different from each other; therefore, even if the ambient temperature Ta at the time of the burn-in test is constant, there is a problem that the chip temperature Tj varies among the power supply areas 111_1 to 111_7 of the semiconductor device 101.

To deal with such a problem, in the technique disclosed in Patent Document 1, a setting frequency is adjusted for each circuit included in the semiconductor device, thereby controlling the amount of heat generation of each circuit to equalize the temperature of the semiconductor device.

However, since the method of adjusting the setting frequency for each circuit is an indirect method from the viewpoint of equalizing thermal stress, large stress is applied to a circuit with a high operating frequency, so that there is a problem that electrical stress applied to each circuit varies among circuits.

Further, a frequency range over which the setting frequency can be adjusted is limited to a range of frequencies at which the circuit can operate; therefore, in the adjustment of the setting frequency, it might be difficult to equalize the chip temperature at the time of the burn-in test within a variable range of limited frequencies.

Hereinafter, a semiconductor device capable of equalizing the chip temperature while suppressing variation in electrical stress applied to each circuit at the time of the burn-in test and a current adjustment method in the semiconductor device will be described in the following embodiments.

### First Embodiment

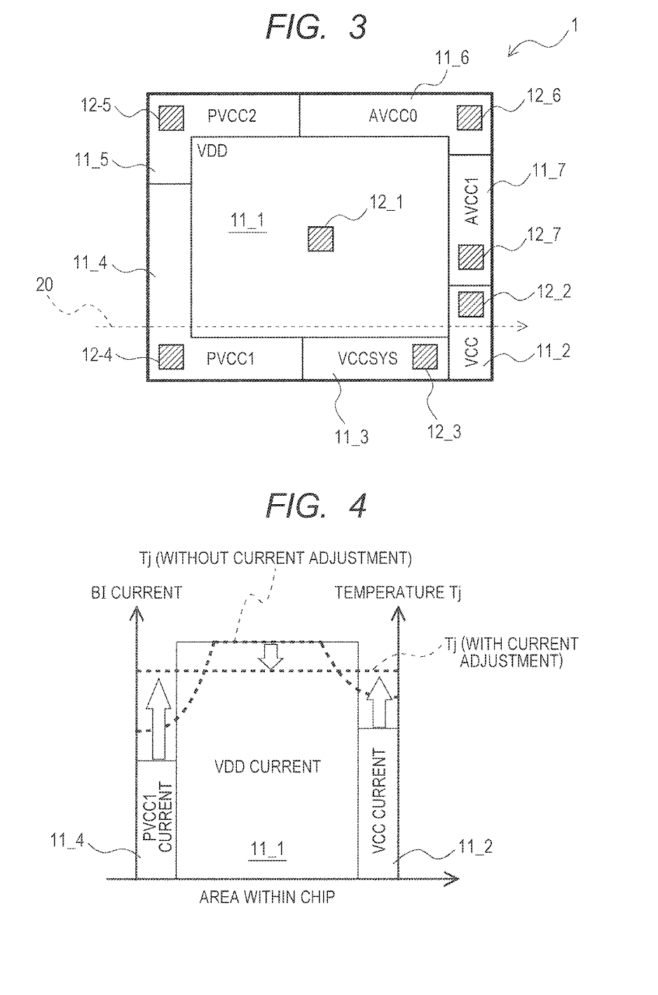

Hereinafter, a first embodiment will be described with reference to the drawings. FIG. 3 is a diagram for explaining a semiconductor device according to the first embodiment. As shown in FIG. 3, the semiconductor device 1 according to this embodiment is a chip-shaped semiconductor device, and includes a plurality of circuit blocks 11_1 to 11_7. The circuit blocks 11_1 to 11_7 are circuit blocks divided into power supply areas coupled to power supply wiring lines different from each other.

In the example shown in FIG. 3, the circuit block 11_1 is a power supply area VDD, the circuit block 11_2 is a power supply area VCC, the circuit block 11_3 is a power supply area VCCSYS, the circuit block 11_4 is a power supply area PVCC1, the circuit block 11_5 is a power supply area PVCC2, the circuit block 11_6 is a power supply area AVCC0, and the circuit block 11_7 is a power supply area AVCC1. Hereinafter, the circuit blocks 11_1 to 11_7 are described as the power supply areas 11_1 to 11_7.

Further, the semiconductor device 1 according to this embodiment includes current adjustment circuits 12_1 to 12_7 in the power supply areas 11_1 to 11_7, respectively. Each current adjustment circuit 12_1 to 12_7 is a circuit capable of adjusting a current amount flowing in the current adjustment circuit itself, and is a circuit for adjusting a current amount flowing in each power supply area 11_1 to 11_7. The current amounts flowing in the current adjustment circuits 12_1 to 12_7 can be adjusted independently from each other.

When a burn-in test is performed on the semiconductor device 1 according to this embodiment, the semiconductor device 1 is set on a burn-in board (not shown) for the burn-in test. Then, an ambient temperature Ta of the semiconductor device 1 is set to a predetermined temperature, and a program for the burn-in test is executed, thereby it passes a predetermined current in each power supply area 11_1 to 11_7 of the semiconductor device 1. Thereby, a temperature acceleration test and a voltage acceleration test are performed on the semiconductor device 1, and it is possible to verify the presence or absence of an initial failure of the semiconductor device 1.

Thus, when the burn-in test is performed on the semiconductor device 1, a burn-in current (BI current) for the burn-in test is passed in each power supply area 11_1 to 11_7 of the semiconductor device 1. However, the current amounts flowing in the power supply areas 11_1 to 11_7 of the semiconductor device 1 are different from each other; therefore, even if the ambient temperature Ta at the time of the burn-in test is constant, the chip temperature Tj might vary among the power supply areas 11_1 to 11_7 of the semiconductor device 1.

Therefore, in the semiconductor device 1 according to this embodiment, the current adjustment circuits 12_1 to 12_7 capable of adjusting the current amounts flowing in the current adjustment circuits themselves respectively are provided in the power supply areas 11_1 to 11_7, and by adjusting the current amounts flowing in the current adjustment circuits 12_1 to 12_7, the current amounts flowing in the power supply areas 11_1 to 11_7 are adjusted.

More specifically, in the case of the power supply area 11 of a large current amount, by decreasing the current amount flowing in the current adjustment circuit 12, it is possible to decrease the total current amount flowing in the power supply area 11. On the other hand, in the case of the power supply area 11 of a small current amount, by increasing the current amount flowing in the current adjustment circuit 12, it is possible to increase the total current amount flowing in the power supply area 11. Thus, by adjusting the current amount flowing in each power supply area 11, it is possible to equalize the chip temperature at the time of the burn-in test. In this specification, when the power supply areas 11_1 to 11_7 are generically called, they are described as the power supply area 11. The same applies to the other constituent elements.

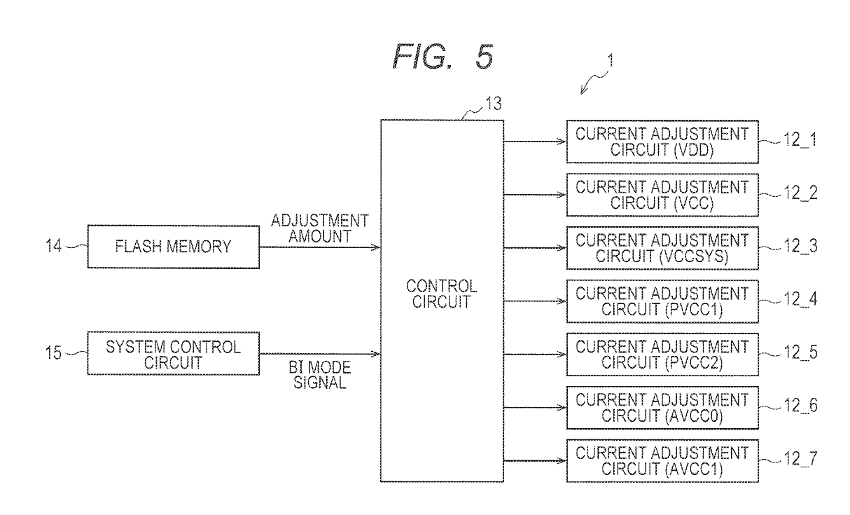

A specific example will be described with reference to FIG. 4. FIG. 4 is a graph showing the BI current and the chip temperature Tj in each power supply area 11_1 to 11_7 of the semiconductor device 1 according to this embodiment. FIG. 4 shows the BI current and the chip temperature Tj in the area within the chip in the direction of an arrow 20 in FIG. 3 as an example.

As shown in FIG. 4, in the case where the current is not adjusted using the current adjustment circuit 12, the BI current amounts flowing in the power supply area PVCC1 (11_4), the power supply area VDD (11_1), and the power supply area VCC (11_2) at the time of the burn-in test are different from each other. In the example shown in FIG. 4, the BI current amount flowing in the power supply area VDD (11_1) is the largest, the BI current amount flowing in the power supply area VCC (11_2) is the second largest, and the BI current amount flowing in the power supply area PVCC1 (11_4) is the smallest.

The chip temperature Tj of each power supply areas 11_1, 11_2, 11_4 increases as the BI current amount flowing in each power supply area 11_1, 11_2, 11_4 increases. Therefore, in the case where the current is not adjusted using the current adjustment circuit 12, there occurs variation in the chip temperature Tj (without current adjustment) of each power supply area 11_1, 11_2, 11_4.

On the other hand, in the case where the current amounts flowing in the power supply areas 11_1, 11_2, 11_4 are adjusted using the current adjustment circuits 12_1, 12_2, 12_4, it is possible to equalize the chip temperatures Tj. That is, as shown in FIG. 4, the current amounts flowing in the power supply area PVCC1 (11_4) and the power supply area VCC (11_2) are increased using the current adjustment circuits 12_4, 12_2, and the current amount flowing in the power supply area VDD (11_1) is decreased using the current adjustment circuit 12_1, so that it is possible to equalize the chip temperatures Tj (with current adjustment) of the power supply areas 11_1, 11_2, 11_4 within the chip.

Thus, in the semiconductor device 1 according to this embodiment, since the current adjustment circuits 12_1 to 12_7 are provided in the power supply areas 11_1 to 11_7, and the current amounts flowing in the power supply areas 11_1 to 11_7 are adjusted using the current adjustment circuits 12_1 to 12_7, it is possible to equalize the chip temperatures at the time of the burn-in test.

Hereinafter, a specific configuration example of the semiconductor device 1 according to this embodiment will be described in detail. FIG. 5 is a block diagram showing a configuration example of the semiconductor device according to this embodiment. As shown in FIG. 5, the semiconductor device 1 according to this embodiment includes the current adjustment circuits 12_1 to 12_7, a control circuit 13, and a flash memory (storage circuit) 14. A system control circuit 15 is a circuit for controlling the burn-in test of the semiconductor device 1, and is a circuit provided separately from the semiconductor device 1.

As shown in FIG. 3, the current adjustment circuits 12_1 to 12_7 are provided in the power supply areas 11_1 to 11_7, respectively. The current adjustment circuits 12_1 to 12_7 are configured to be able to adjust the current amounts flowing in the current adjustment circuits themselves, respectively. In the example shown in FIGS. 3, 5, one current adjustment circuit 12 is disposed in one power supply area 11; however, in this embodiment, the number of current adjustment circuits 12 disposed in each power supply area 11 may be two or more. For example, in the case where the circuit area of the power supply area 11 is large, a plurality of current adjustment circuits 12 may be disposed in one power supply area 11.

The flash memory 14 shown in FIG. 5 stores the adjustment amount of each current adjustment circuit 12_1 to 12_7. The adjustment amount of each current adjustment circuit 12_1 to 12_7 is determined beforehand (details will be described later), and the flash memory 14 stores the adjustment amount.

When a burn-in (BI) mode signal indicating a burn-in mode is supplied from the system control circuit 15, the control circuit 13 controls the current amount flowing in the current adjustment circuit 12_1 to 12_7 in accordance with the adjustment amount stored in the flash memory 14.

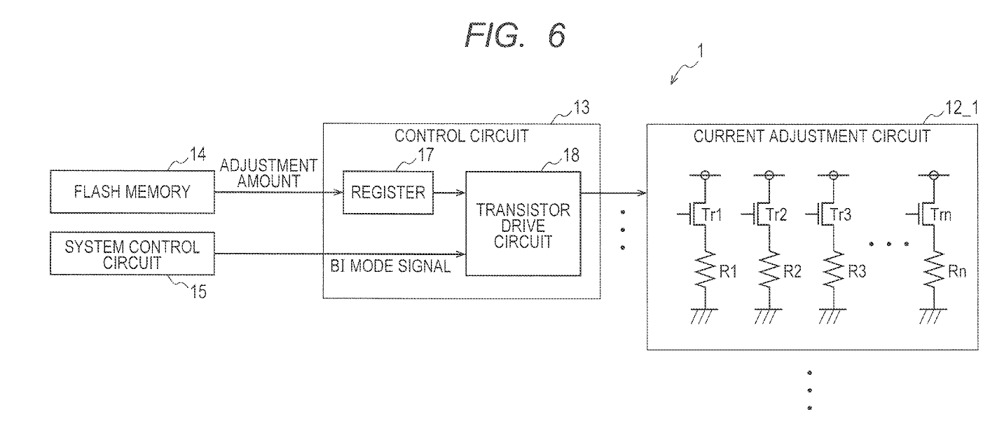

FIG. 6 is a block diagram showing a specific configuration example of the semiconductor device according to this embodiment. As shown in FIG. 6, in the semiconductor device 1 according to this embodiment, the current adjustment circuit 12_1 includes a plurality of transistors Tr1 to Trn and a plurality of resistance elements R1 to Rn (n is a natural number of 2 or more). The transistors Tr1 to Trn and the resistance elements R1 to Rn are coupled in series with each other, respectively. While FIG. 6 shows the configuration of the current adjustment circuit 12_1 as an example, the other current adjustment circuits 12_2 to 12_7 have the same configuration.

In the example shown in FIG. 6, the drain of each transistor Tr1 to Trn is coupled to a power supply line on a high potential side, and the source of each transistor Tr1 to Trn is coupled to one end of each resistance element R1 to Rn. The other end of each resistance element R1 to Rn is coupled to a ground potential. Therefore, when a high-level signal is supplied to the gate of each transistor Tr1 to Trn, each transistor Tr1 to Trn is turned on, and a current flows through each resistance element R1 to Rn. In the configuration shown in FIG. 6, each transistor Tr1 to Trn is an N-type transistor; however, each transistor Tr1 to Trn may be a P-type transistor.

The control circuit 13 changes the number of resistance elements R1 to Rn through which the current is passed, and thereby can control the current amount flowing in the current adjustment circuit 12_1 to 12_7. In other words, the control circuit 13 changes the number of turned-on transistors Tr1 to Trn, and thereby can control the current amount flowing in the current adjustment circuit 12_1 to 12_7. Since the resistance element generates heat by passing the current through the resistance element, it is possible to adjust the amount of heat generation of each current adjustment circuit by changing the number of turned-on transistors.

As shown in FIG. 6, the control circuit 13 includes a register 17 and a transistor drive circuit 18. The register 17 stores the adjustment amount read from the flash memory 14. The adjustment amount is the number of turned-on transistors among the transistors Tr1 to Trn included in each current adjustment circuit 12_1 to 12_7.

When the BI mode signal is supplied from the system control circuit 15, the transistor drive circuit 18 drives the transistors Tr1 to Trn of each current adjustment circuit 12_1 to 12_7 in accordance with the adjustment amount stored in the register 17. More specifically, the transistor drive circuit 18 turns on a predetermined number of transistors among the transistors Tr1 to Trn of each current adjustment circuit 12_1 to 12_7, based on the adjustment amount (i.e., the number of turned-on transistors) stored in the register 17.

Thereby, a current corresponding to the adjustment amount flows in each current adjustment circuit 12_1 to 12_7, so that the current amount flowing in each power supply area 11_1 to 11_7 is adjusted. That is, the current adjustment circuit 12_1 to 12_7 configured with pairs of transistors and resistance elements is embedded in each power supply area 11_1 to 11_7, and adjustment for correcting an undercurrent or decreasing an overcurrent during the burn-in test for each power supply area 11_1 to 11_7 is performed, thereby making it possible to suppress the occurrence of a temperature gradient in the chip at the time of the burn-in test. Therefore, it is possible to equalize the chip temperature at the time of the burn-in test.

Next, the flow of the current adjustment method in the semiconductor device according to this embodiment will be described. The following parameters are only examples, and in the current adjustment method in the semiconductor device according to this embodiment, parameters other than the following parameters may be used. Further, although the burn-in test is a test performed in the mass production stage of the semiconductor device, the following advance preparation is preferably performed, for example, in an experimental stage before the mass production stage.

Preconditions for the advance preparation are defined as follows.

(1) There is no variation in current among a plurality of semiconductor devices (chips).
(2) There is no variation among currents flowing through the pairs of resistors and transistors in the same current adjustment circuit 12.
(3) The number of pairs of resistors and transistors in each current adjustment circuit 12_1 to 12_7 is 20 (i.e., each current adjustment circuit includes the resistors R1 to R20 and the transistors Tr1 to Tr20).
(4) In a state where each current adjustment circuit 12_1 to 12_7 does not perform the current adjustment, 10 transistors are turned on, and the other 10 transistors are turned off (i.e., the current flows through 10 pairs of resistors and transistors).
(5) The controlling of the current adjustment amount of each current adjustment circuit 12_1 to 12_7 by the control circuit 13 is synonymous with the controlling of the number of turned-on transistors.
(6) As for the ambient temperature Ta at the time of the burn-in test, it is Ta=125° C.
(7) As for the target value of a chip surface temperature at the time of the burn-in test, when the chip temperature reaches a steady state, the temperature of each power supply area 11_1 to 11_7 is measured using a temperature sensor incorporated in the chip, and the median value of the measurement result is determined as a target temperature Tja.
(8) One temperature sensor is provided for each current adjustment circuit 12_1 to 12_7 in the power supply areas 11_1 to 11_7. Further, the advance preparation of a semiconductor device that does not incorporate the temperature sensor will be described in a fifth embodiment.

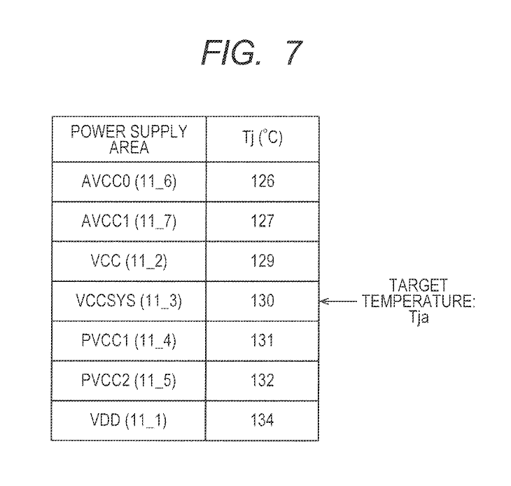

Next, the advance preparation will be described. First, one representative chip (semiconductor device) is set on the burn-in board (not shown) for the burn-in test. Then, the ambient temperature Ta in the burn-in test is set to Ta=125° C. Further, the representative chip is brought into the state where each current adjustment circuit 12_1 to 12_7 of the representative chip does not perform the current adjustment, that is, the state where 10 transistors are turned on in each current adjustment circuit 12_1 to 12_7. Then, the program for the burn-in test is executed, and the burn-in test is performed on the representative chip, thereby it passes the predetermined current in each power supply area 11_1 to 11_7. In this state, the temperature of each power supply area 11_1 to 11_7 is measured using the temperature sensor provided in each power supply area 11_1 to 11_7. FIG. 7 shows the measurement result.

As shown in FIG. 7, in the state where each current adjustment circuit 12_1 to 12_7 does not perform the current adjustment, the chip temperatures Tj of power supply area 11_1 to 11_7 vary each other. In this embodiment, for example, the median value of the chip temperature Tj of each power supply area 11_1 to 11_7 is determined as the target temperature Tja. More specifically, the chip temperature Tj=130° C. of the power supply area (VCCSYS) 11_3 is determined as the target temperature Tja.

Then, the current amount of each current adjustment circuit 12_1 to 12_7 is adjusted so that the value of the temperature sensor in each power supply area 11_1 to 11_7 of the representative chip (semiconductor device) becomes the target temperature Tja=130° C. More specifically, the value of the register 17 in the control circuit 13 (see FIG. 6) is rewritten using an evaluation program or the like, thereby adjusting the current amount of each current adjustment circuit 12_1 to 12_7. After the current amount of each current adjustment circuit 12_1 to 12_7 is adjusted, when the temperature of each power supply area 11_1 to 11_7 of the representative chip reaches the steady state, the value of the temperature sensor of each power supply area 11_1 to 11_7 is read. This operation is repeated, therefore it obtains the current adjustment amount when each power supply area 11_1 to 11_7 reaches the target temperature Tja=130° C., that is, the number of turned-on transistors.

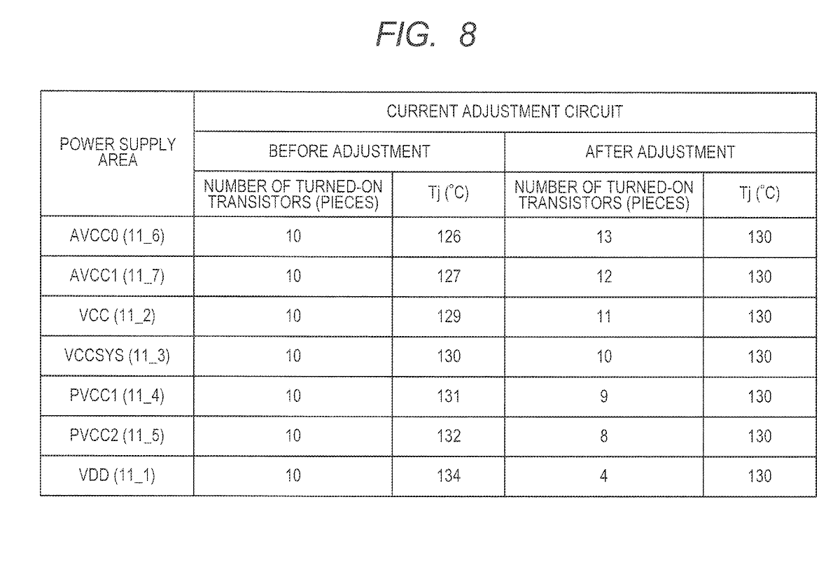

FIG. 8 is a table showing the thus-obtained current adjustment amount of each current adjustment circuit 12_1 to 12_7. For example, the chip temperature Tj of the power supply area (AVCC0) 11_6 before the current adjustment is 126° C., which is lower than the target temperature Tja=130° C. Accordingly, in this case, the number of turned-on transistors is increased, thereby raising the temperature of the power supply area (AVCC0) 11_6. In the example shown in FIG. 8, 13 transistors included in the current adjustment circuit 12_6 are turned on (i.e., the number of turned-on transistors is increased by 3), therefore it adjusts the chip temperature Tj of the power supply area (AVCC0) 11_6 to 130° C.

Further, since the chip temperature Tj of the power supply area (AVCC1) 11_7 before the current adjustment is 127° C.; in this case, 12 transistors included in the current adjustment circuit 12_7 are turned on (i.e., the number of turned-on transistors is increased by 2), therefore it adjusts the chip temperature Tj of the power supply area (AVCC1) 11_7 to 130° C. Further, since the chip temperature Tj of the power supply area (VCC) 11_2 before the current adjustment is 129° C.; in this case, 11 transistors included in the current adjustment circuit 12_2 are turned on (i.e., the number of turned-on transistors is increased by 1), therefore it adjusts the chip temperature Tj of the power supply area (VCC) 11_2 to 130° C.

On the other hand, the chip temperature Tj of the power supply area (PVCC1) 11_4 before the current adjustment is 131° C., which is higher than the target temperature Tja=130° C. Accordingly, in this case, the number of turned-on transistors is decreased, thereby lowering the temperature of the power supply area (PVCC1) 11_4. In the example shown in FIG. 8, 9 transistors included in the current adjustment circuit 12_4 are turned on (i.e., the number of turned-on transistors is decreased by 1), therefore it adjusts the chip temperature Tj of the power supply area (PVCC1) 11_4 to 130° C.

Further, since the chip temperature Tj of the power supply area (PVCC2) 11_5 before the current adjustment is 132° C.; in this case, 8 transistors included in the current adjustment circuit 12_5 are turned on (i.e., the number of turned-on transistors is decreased by 2), therefore it adjusts the chip temperature Tj of the power supply area (PVCC2) 11_5 to 130° C. Further, since the chip temperature Tj of the power supply area (VDD) 11_1 before the current adjustment is 134° C.; in this case, 4 transistors included in the current adjustment circuit 12_1 are turned on (i.e., the number of turned-on transistors is decreased by 6), therefore it adjusts the chip temperature Tj of the power supply area (VDD) 11_1 to 130° C.

The adjustment amount of each current adjustment circuit 12_1 to 12_7 obtained by the advance preparation, that is, the number of turned-on transistors is stored in the flash memory 14, as the adjustment amount of the current adjustment circuit 12_1 to 12_7.

Next, the burn-in test will be described. The burn-in test is a test performed in the mass production stage of the semiconductor device, and is a test performed to remove an initial failure product before shipment of the product.

After the semiconductor device is manufactured, each semiconductor device 1 subject to the burn-in test is set on the burn-in board (not shown) for the burn-in test. Then, the ambient temperature Ta of each semiconductor device 1 is set to the predetermined temperature, and the program for the burn-in test is executed. Further, the adjustment value of the current adjustment circuit stored in the flash memory 14 of each semiconductor device 1 is read, and the read adjustment value is written to the register 17 (see FIG. 6).

Then, when the BI mode signal is supplied from the system control circuit 15, the transistor drive circuit drives the transistors Tr1 to Tr20 of each current adjustment circuit 12_1 to 12_7 in accordance with the adjustment amount stored in the register 17. More specifically, the transistor drive circuit 18 turns on transistors whose number corresponds to the adjustment amount (i.e., the number of turned-on transistors shown in FIG. 8) stored in the register 17 among the transistors Tr1 to Tr20 of each current adjustment circuit 12_1 to 12_7.

Thereby, the current corresponding to the adjustment amount flows in each current adjustment circuit 12_1 to 12_7, so that the current amount flowing in each power supply area 11_1 to 11_7 is adjusted. In this state, the program for the burn-in test is executed. Therefore, it is possible to adjust the chip temperature Tj of each power supply area 11_1 to 11_7 at the time of the burn-in test to the target temperature Tja=130° C., and to equalize the chip temperature at the time of the burn-in test.

As described above, in the semiconductor device 1 according to this embodiment, the current adjustment circuits 12_1 to 12_7 are provided in the power supply areas 11_1 to 11_7, and the current amounts flowing in the power supply areas 11_1 to 11_7 are adjusted using the current adjustment circuits 12_1 to 12_7. Therefore, it is possible to equalize the chip temperatures at the time of the burn-in test.

In the above description of this embodiment, the current amount flowing in each power supply area 11_1 to 11_7 is adjusted by increasing or decreasing the current value flowing in each current adjustment circuit 12_1 to 12_7. That is, in the case where each current adjustment circuit 12_1 to 12_7 includes 20 transistors; from the state where 10 transistors are turned on, which is the state where the current is not adjusted, the current amount flowing in each power supply area 11_1 to 11_7 is adjusted by increasing or decreasing the number of turned-on transistors in accordance with the current adjustment amount.

However, in this embodiment, the current amount flowing in each power supply area 11_1 to 11_7 may be adjusted by increasing the current value flowing in each current adjustment circuit 12_1 to 12_7. That is, in the case where each current adjustment circuit 12_1 to 12_7 includes 20 transistors; from the state where all transistors are turned off, which is the state where the current is not adjusted, the current amount flowing in each power supply area 11_1 to 11_7 may be adjusted by increasing the number of turned-on transistors in accordance with the current adjustment amount.

On the other hand, the current amount flowing in each power supply area 11_1 to 11_7 may be adjusted by decreasing the current value flowing in each current adjustment circuit 12_1 to 12_7. That is, in the case where each current adjustment circuit 12_1 to 12_7 includes 20 transistors; from the state where all transistors are turned on, which is the state where the current is not adjusted, the current amount flowing in each power supply area 11_1 to 11_7 may be adjusted by decreasing the number of turned-on transistors in accordance with the current adjustment amount.

### Second Embodiment

Next, a second embodiment will be described. In the following description of the second embodiment, a control circuit performs feedback control on the current adjustment circuit 12, using the value of the temperature sensor provided in each power supply area 11 at the time of the burn-in test. This embodiment is the same as the first embodiment except that the control circuit performs feedback control on the current adjustment circuit 12; therefore, the same constituent elements are denoted by the same reference numerals, and their description will not be repeated as appropriate.

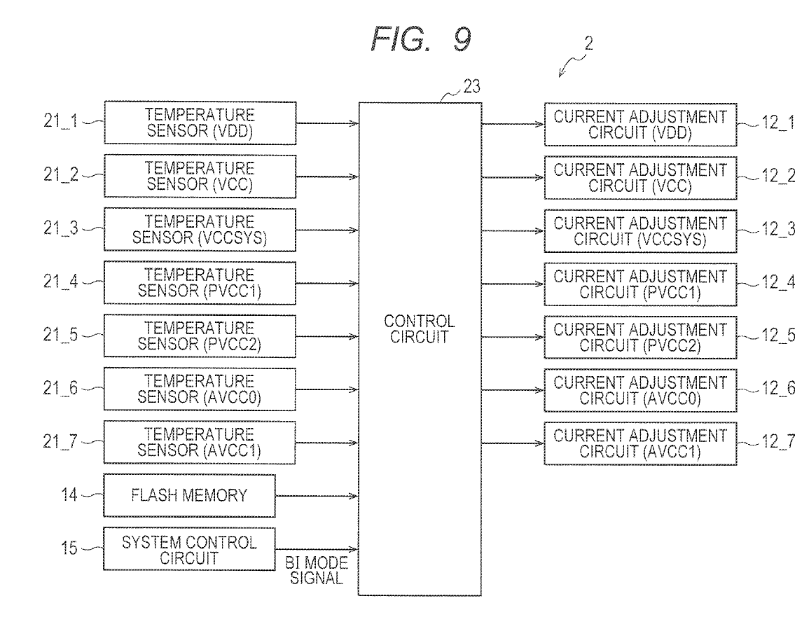

FIG. 9 is a block diagram showing a configuration example of a semiconductor device according to this embodiment. As shown in FIG. 9, the semiconductor device 2 according to this embodiment includes the current adjustment circuits 12_1 to 12_7, temperature sensors 21_1 to 21_7, the control circuit 23, and the flash memory (storage circuit) 14. The system control circuit 15 is a circuit for controlling the burn-in test of the semiconductor device 2, and is a circuit provided separately from the semiconductor device 2. Since the current adjustment circuits 12_1 to 12_7, the flash memory (storage circuit) 14, and the system control circuit 15 are basically the same as in the first embodiment, their description will not be repeated.

The temperature sensors 21_1 to 21_7 are provided in the power supply areas 11_1 to 11_7, and measure the chip temperatures Tj of the power supply areas 11_1 to 11_7, respectively. The temperature sensors 21_1 to 21_7 can be configured with thermistors or the like, and are preferably provided near the current adjustment circuits 12_1 to 12_7.

The control circuit 23 performs the feedback control of the current amount flowing in the current adjustment circuit 12_1 to 12_7 so that the temperature Tj measured by the temperature sensor 21_1 to 21_7 becomes the preset target temperature Tja.

The flash memory 14 stores the initial value of the adjustment amount of the current adjustment circuit 12_1 to 12_7 and the target temperature Tja of the semiconductor device 2. The control circuit 23 controls the current amount flowing in the current adjustment circuit 12_1 to 12_7 in accordance with the initial value of the adjustment amount, and then performs the feedback control of the current amount flowing in the current adjustment circuit 12_1 to 12_7 so that the temperature measured by the temperature sensor 21_1 to 21_7 becomes the target temperature Tja.

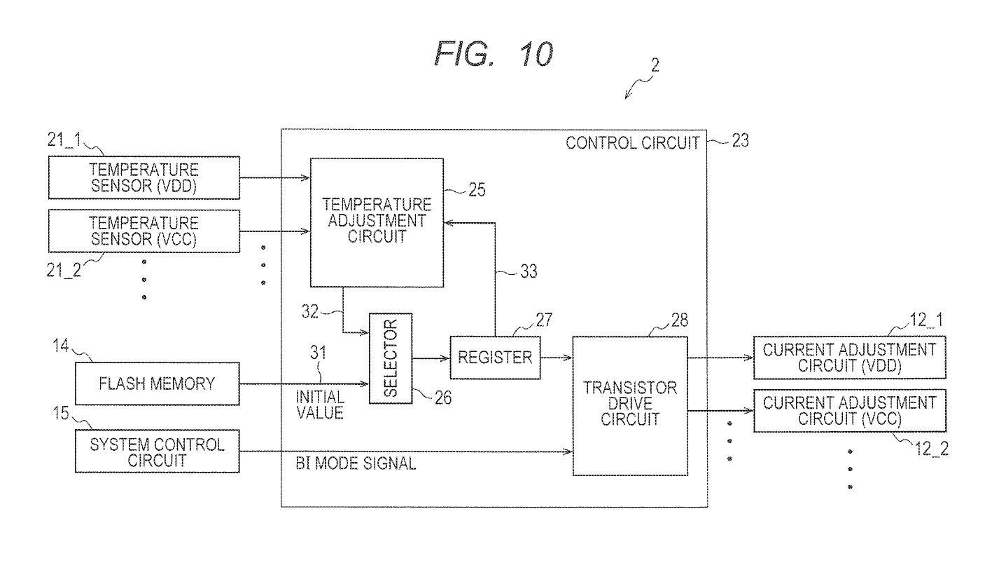

FIG. 10 is a block diagram showing a specific configuration example of the semiconductor device according to this embodiment. As shown in FIG. 10, in the semiconductor device 2 according to this embodiment, the control circuit 23 includes a temperature adjustment circuit 25, a selector 26, a register 27, and a transistor drive circuit 28.

When the BI mode signal is supplied from the system control circuit 15, the transistor drive circuit 28 drives the transistors Tr1 to Trn (see FIG. 6) of each current adjustment circuit 12_1 to 12_7 in accordance with the adjustment amount stored in the register 27. More specifically, the transistor drive circuit 28 turns on a predetermined number of transistors among the transistors Tr1 to Trn of each current adjustment circuit 12_1 to 12_7, based on the adjustment amount (i.e., the number of turned-on transistors) stored in the register 27.

The register 27 stores the initial value 31 of the adjustment amount read from the flash memory 14 or a control value 32 outputted from the temperature adjustment circuit 25. That is, the initial value 31 of the adjustment amount read from the flash memory 14 and the control value 32 outputted from the temperature adjustment circuit 25 are supplied to the selector 26, and the selector 26 selects and outputs either one of the supplied initial value 31 and control value 32 to the register 27.

The temperature adjustment circuit 25 performs the feedback control of the current amount flowing in the current adjustment circuit 12_1 to 12_7 so that the temperature measured by the temperature sensor 21_1 to 21_7 becomes the target temperature Tja. More specifically, the temperature measured by the temperature sensor 21_1 to 21_7 and the adjustment amount 33 (i.e., corresponding to the initial value 31 of the adjustment amount or the control value 32) stored in the register 27 are supplied to the temperature adjustment circuit 25. Then, the temperature adjustment circuit 25 determines the adjustment amount of each current adjustment circuit 12_1 to 12_7 so that the temperature measured by the temperature sensor 21_1 to 21_7 becomes the target temperature Tja. Each determined adjustment amount is supplied to the selector 26, as the control value 32. The control value 32 supplied to the selector 26 is newly written to the register 27, as the control value of the feedback control. The transistor drive circuit 28 controls each current adjustment circuit 12_1 to 12_7, using the new control value (adjustment amount) written in the register 27. By this control, each current adjustment circuit 12_1 to 12_7 undergoes the feedback control.

Next, the operation at the time of the burn-in test of the semiconductor device according to this embodiment will be specifically described. Since the advance preparation is the same as in the first embodiment, the description will not be repeated.

After the semiconductor device is manufactured, each semiconductor device 2 subject to the burn-in test is set on the burn-in board (not shown) for the burn-in test. Then, the ambient temperature Ta of each semiconductor device 2 is set to the predetermined temperature, and the program for the burn-in test is executed. In an initial stage, the selector 26 is set so as to select the initial value 31 outputted from the flash memory 14. Therefore, the initial value 31 of the adjustment value of the current adjustment circuit read from the flash memory 14 is written to the register 27.

Then, when the BI mode signal is supplied from the system control circuit 15, the transistor drive circuit drives the transistors Tr1 to Tr20 of each current adjustment circuit 12_1 to 12_7 in accordance with the initial value 31 of the adjustment amount stored in the register 27. More specifically, the transistor drive circuit 28 turns on transistors whose number corresponds to the initial value 31 of the adjustment amount stored in the register 27 among the transistors Tr1 to Tr20 of each current adjustment circuit 12_1 to 12_7. Thereby, the current corresponding to the adjustment amount flows in each current adjustment circuit 12_1 to 12_7, so that the current amount flowing in each power supply area 11_1 to 11_7 is adjusted.

Then, the temperature adjustment circuit 25 performs the feedback control of the current amount flowing in the current adjustment circuit 12_1 to 12_7 so that the temperature measured by the temperature sensor 21_1 to 21_7 becomes the target temperature Tja. At this time, the selector 26 selects and outputs the control value 32 outputted from the temperature adjustment circuit 25 to the register 27.

That is, the temperature adjustment circuit 25 determines the adjustment amount of each current adjustment circuit 12_1 to 12_7 so that the temperature measured by the temperature sensor 21_1 to 21_7 becomes the target temperature Tja. Each determined adjustment amount is written to the register 27, as the control value 32. The transistor drive circuit 28 controls each current adjustment circuit 12_1 to 12_7, using the new control value (adjustment amount) written in the register 27. By this control, each current adjustment circuit 12_1 to 12_7 undergoes the feedback control.

For example, if the temperature measured by the temperature sensor 21_1 to 21_7 is lower than the target temperature Tja, the temperature adjustment circuit 25 outputs a value obtained by adding a predetermined value (e.g., “1”) to the current adjustment amount 33 of the register 27, as the control value 32. Thereby, the adjustment amount of the register 27 is rewritten to the value obtained by adding the predetermined value, the transistor drive circuit 28 increases the current amount flowing in the current adjustment circuit 12_1 to 12_7.

On the other hand, if the temperature measured by the temperature sensor 21_1 to 21_7 is higher than the target temperature Tja, the temperature adjustment circuit 25 outputs a value obtained by subtracting a predetermined value (e.g., from the current adjustment amount 33 of the register 27, as the control value 32. Thereby, the adjustment amount of the register 27 is rewritten to the value obtained by subtracting the predetermined value, the transistor drive circuit 28 decreases the current amount flowing in the current adjustment circuit 12_1 to 12_7. By this control, each current adjustment circuit 12_1 to 12_7 undergoes the feedback control.

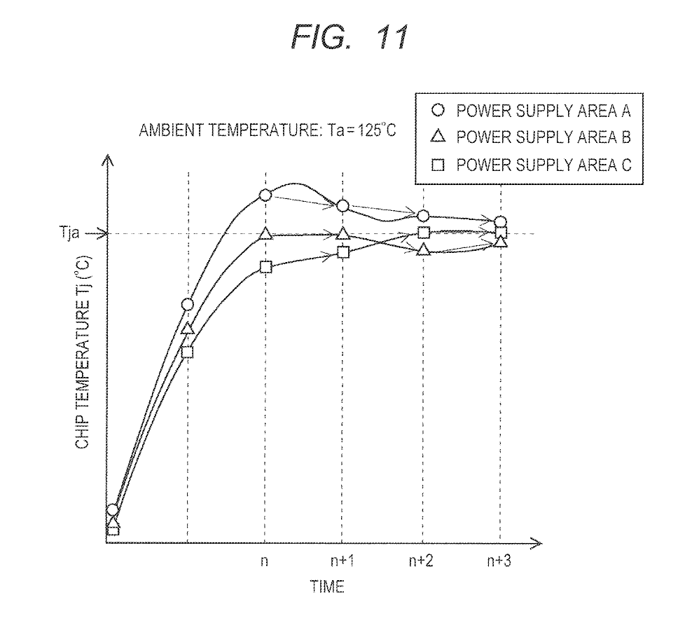

FIG. 11 is a graph showing the progression of the chip temperature Tj with respect to time in the case of performing the feedback control on each current adjustment circuit in the semiconductor device according to this embodiment.

FIG. 11 shows the progression of the chip temperatures Tj of three power supply areas A to C as an example. When the burn-in test is performed on the semiconductor device, the chip temperatures Tj of the power supply areas A to C rise, as shown in FIG. 11. Then, at timing n, the chip temperature Tj of the power supply area A is the highest, the chip temperature Tj of the power supply area B is the second highest, and the chip temperature Tj of the power supply area C is the lowest. At this time, the median value of the chip temperatures Tj is the chip temperature Tj of the power supply area B; therefore, the current adjustment circuits of the power supply areas A and C are controlled, with the chip temperature Tj of the power supply area B as the target temperature Tja.

Then, at timing n+1, the temperatures of the three power supply areas A to C are measured, and the median value of the chip temperatures Tj is the chip temperature Tj of the power supply area B; therefore, the current adjustment circuits of the power supply areas A and C are controlled continuously with the chip temperature Tj of the power supply area B as the target temperature Tja.

Then, at timing n+2, the temperatures of the three power supply areas A to C are measured, and the median value of the chip temperatures Tj is the chip temperature Tj of the power supply area C; therefore, the current adjustment circuits of the power supply areas A and B are controlled with the chip temperature Tj of the power supply area C as the target temperature Tja.

Then, at timing n+3, the temperatures of the three power supply areas A to C are measured, and the median value of the chip temperatures Tj is the chip temperature Tj of the power supply area C; therefore, the current adjustment circuits of the power supply areas A and B are controlled continuously with the chip temperature Tj of the power supply area C as the target temperature Tja.

By repeating the above operation, it is possible to gradually converge the chip temperature Tj of each power supply area A to C to the target temperature Tja.

As described above, in the semiconductor device 2 according to this embodiment, during the burn-in test, the temperature of each power supply area 11_1 to 11_7 is measured using each temperature sensor 21_1 to 21_7, and the feedback control of the current amount flowing in the current adjustment circuit 12_1 to 12_7 is performed so that the measured temperature becomes the target temperature Tja. Therefore, it is possible to continuously and further equalize the chip temperature during the burn-in test in comparison with the first embodiment.

### Third Embodiment

Next, a third embodiment will be described. In the first and second embodiments, the equalization of the chip temperatures in the same semiconductor device (same chip) has been described. In this embodiment, the equalization of temperatures among a plurality of same chips in the same burn-in test process will be described. In the following description, the same parts as in the first and second embodiments will not be repeatedly described.

In this embodiment, assume that each semiconductor device (chip) is provided with the current adjustment circuits 12_1 to 12_7 and the temperature sensors 21_1 to 21_7 (see FIG. 9) in the power supply areas 11_1 to 11_7 (see FIG. 3), respectively. The initial value of the adjustment amount of each current adjustment circuit 12_1 to 12_7 in the power supply areas 11_1 to 11_7 is set to the value (see FIG. 8) obtained in the first embodiment. Even in different chips, the same initial value is applied to the same power supply area 11_1 to 11_7. With these contents as preconditions, the following advance preparation is performed.

First, a plurality of same chips are prepared as the advance preparation. Then, a median value Tm1 of the temperatures of the power supply areas 11_1 to 11_7 at the ambient temperature Ta at the time of the burn-in test is obtained for each chip. Even among the same chips, the median value Tm1 slightly varies from chip to chip due to manufacturing variation. At this time, the initial value of the adjustment amount of each current adjustment circuit 12_1 to 12_7 is set to the value (see FIG. 8) obtained in the first embodiment, that is, the adjustment amount (the number of turned-on transistors) for setting each power supply area 11_1 to 11_7 to the target temperature Tja=130° C.

Further, a median value Tm2 of temperatures among the chips, using the median value Tm1 of temperatures obtained for each chip. Then, the median value Tm2 of the temperatures among the chips is set to the target temperature Tja during the burn-in test.

That is, in this embodiment, as the advance preparation, first, the median value Tm1 of variation of the chip temperatures in the chip is obtained for each chip. Then, the median value Tm2 of variation (corresponding to variation among the chips) of the median value Tm1 of each chip is obtained, and set to the target temperature Tja.

Then, in this embodiment, when the burn-in test is performed, each current adjustment circuit 12_1 to 12_7 of each chip is controlled so that all the power supply areas of all the chips reach the target temperature Tja (=Tm2). Thereby, it is possible to equalize the temperatures in the chip and the temperatures among the chips at the time of the burn-in test.

In this embodiment, when the burn-in test is performed, the feedback control of the current amount flowing in the current adjustment circuit 12_1 to 12_7 may be performed as described in the second embodiment. That is, in this embodiment, during the burn-in test, the temperature of each power supply area 11_1 to 11_7 may be measured using each temperature sensor 21_1 to 21_7, and the feedback control of the current amount flowing in the current adjustment circuit 12_1 to 12_7 may be performed so that the measured temperature becomes the target temperature Tja. By this feedback control, it is possible to continuously and further equalize the temperatures in the chip and the temperatures among the chips during the burn-in test.

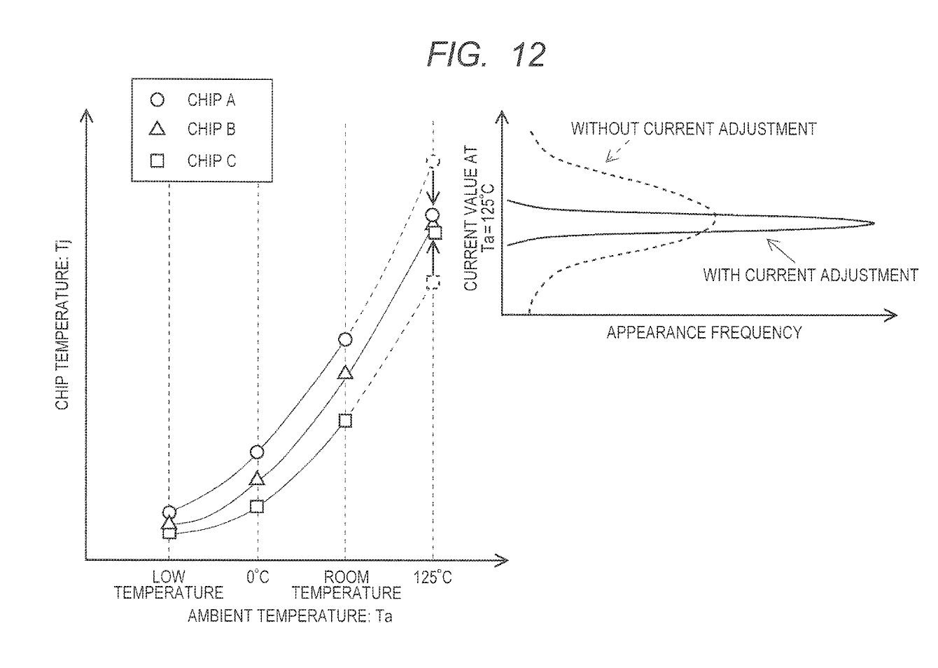

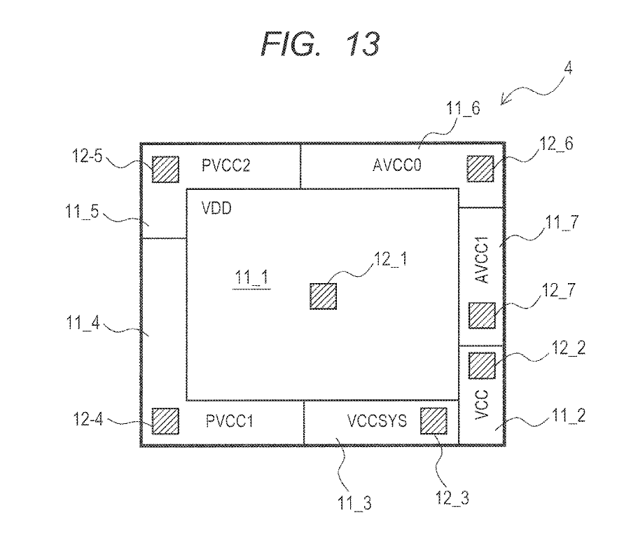

FIG. 12 is a graph showing the temperature Tj of each chip of the semiconductor device according to this embodiment, and is a diagram for explaining an effect when the above-described current adjustment control is performed on the current adjustment circuit included in each chip. FIG. 12 shows the chip temperatures Tj of three chips A to C as an example.

As shown in FIG. 12, when the burn-in test is performed on each chip A to C at the ambient temperature Ta=125° C.; if the current flowing in each chip A to C is not adjusted using the current adjustment circuit, there occurs variation in the chip temperature Tj of each chip A to C. More specifically, in FIG. 12, the temperature Tj of the chip A is higher than the temperature Tj of the chip B, and the temperature Tj of the chip C is lower than the temperature Tj of the chip B (the plots of the chips A, C are shown by broken lines in FIG. 12).

On the other hand, in the case where the current flowing in each chip A to C is adjusted using the current adjustment circuit, that is, in the case where each current adjustment circuit 12_1 to 12_7 of each chip A to C is controlled so that all the power supply areas 11_1 to 11_7 of all the chips A to C reach the target temperature Tja as described above, it is possible to equalize the temperatures in each chip and the temperatures among the chips. More specifically, as shown in FIG. 12, the temperature Tj of the chip A approaches the temperature Tj of the chip B, and the temperature Tj of the chip C approaches the temperature Tj of the chip B; therefore, it is possible to equalize the temperatures in each chip and the temperatures among the chips.

Thus, by adjusting the current amount flowing in each chip A to C, it is possible to converge the temperatures in each chip and the temperatures among the chips to the target temperature Tja. Therefore, as shown in FIG. 12, it is possible to increase the appearance frequency (corresponding to the number of chips) of each chip at the target temperature Tja.

By this embodiment described above, it is possible to equalize the temperatures in each chip and the temperatures among the chips.

### Fourth Embodiment

Next, a fourth embodiment will be described. In the above-described first to third embodiments, at the time of the burn-in test, the current adjustment circuits 12_1 to 12_7 provided in the power supply areas 11_1 to 11_7 are operated at the same timing.

When the adjustment amount of the current adjustment circuit 12_1 to 12_7 is changed, the current amount increases or decreases due to the change of the adjustment amount, and the chip temperature Tj of each power supply area 11_1 to 11_7 also rises or falls. Since the circuit area and circuit density of each power supply area 11_1 to 11_7 are different for each power supply area 11_1 to 11_7, a time until the chip temperature Tj rises or falls and reaches a steady state (constant temperature) is different for each power supply area 11_1 to 11_7.

Therefore, if the temperature of a predetermined power supply area in a non-steady state is affected by the temperature of another power supply area, there is a problem that the time until the temperature of the predetermined power supply area reaches the steady state is prolonged or the temperature of the predetermined power supply area rises or falls more than assumed. That is, if the temperature of the predetermined power supply area under adjustment is affected by the temperature of another power supply area, the temperature of the predetermined power supply area might not be adjusted properly.

In the fourth embodiment described below, to solve the above problem, the current amounts flowing in the current adjustment circuits 12_1 to 12_7 are controlled in order among a plurality of circuit blocks. Since the other configuration is the same as in the first to third embodiments, the description will not be repeated.

As shown in FIG. 13, a semiconductor device 4 according to this embodiment is a chip-shaped semiconductor device, and includes a plurality of circuit blocks 11_1 to 11_7. The circuit blocks 11_1 to 11_7 are circuit blocks divided into power supply areas coupled to power supply wiring lines different from each other, and configure the power supply areas 11_1 to 11_7.

Further, the semiconductor device 4 according to this embodiment includes the current adjustment circuits 12_1 to 12_7 in the power supply areas 11_1 to 11_7, respectively. Each current adjustment circuit 12_1 to 12_7 is a circuit capable of adjusting a current amount flowing in the current adjustment circuit itself, and is a circuit for adjusting a current amount flowing in each power supply area 11_1 to 11_7. The current amounts flowing in the current adjustment circuits 12_1 to 12_7 can be adjusted independently from each other. Since the semiconductor device 4 shown in FIG. 13 is the same as the semiconductor device 1 described in the first embodiment (FIG. 3), the description will not be repeated.

In this embodiment, when the burn-in test is performed, a plurality of semiconductor devices 4 (chips) subject to the burn-in test is set on the burn-in board (not shown) for the burn-in test. Then, the ambient temperature Ta of each semiconductor device 4 is set to the predetermined temperature, and the program for the burn-in test is executed.

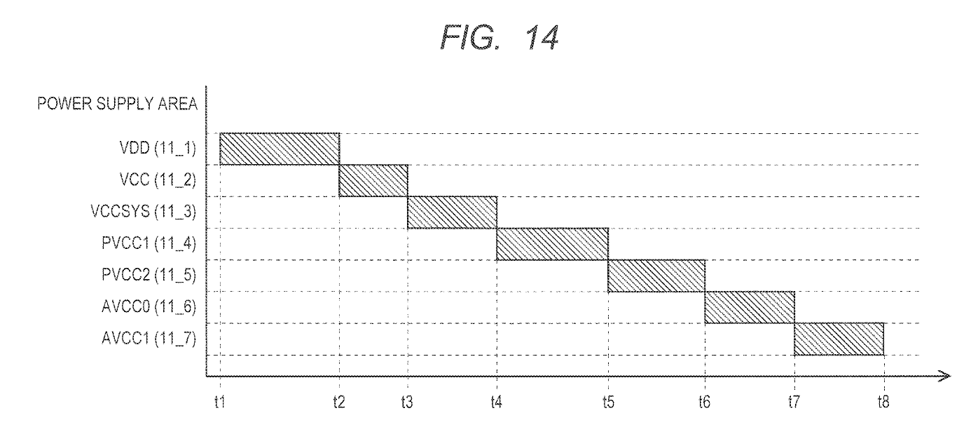

In this embodiment, as shown in a timing chart of FIG. 14, in each chip, the current amounts flowing in the current adjustment circuits 12_1 to 12_7 provided in the power supply areas 11_1 to 11_7 are controlled in order among the power supply areas 11_1 to 11_7.

More specifically, as shown in FIG. 14, between timing t1 and timing t2, the current amount flowing in the current adjustment circuit 12_1 of the power supply area VDD (11_1) is controlled. In this case, there is included, between timing t1 and timing t2, a time until the current amount flowing in the current adjustment circuit 12_1 is controlled and the temperature of the power supply area VDD (11_1) reaches the steady state. At this time, the feedback control of the current amount flowing in the current adjustment circuit 12_1 may be performed using the value of the temperature sensor provided in the power supply area VDD (11_1).

Then, between timing t2 and timing t3, the current amount flowing in the current adjustment circuit 12_2 of the power supply area VCC (11_2) is controlled. In this case as well, there is included, between timing t2 and timing t3, a time until the current amount flowing in the current adjustment circuit 12_2 is controlled and the temperature of the power supply area VCC (11_2) reaches the steady state.

Subsequently, in the same way, the current amounts flowing in the current adjustment circuits 12_3 to 12_7 provided in the power supply areas 11_3 to 11_7 are controlled in the order of the power supply area VCCSYS (11_3), the power supply area PVCC1 (11_4), the power supply area PVCC2 (11_5), the power supply area AVCC0 (11_6), and the power supply area AVCC1 (11_7). Further, the power supply area that has already been controlled is affected by temperature change caused by controlling the power supply area that is newly controlled. Accordingly, in the power supply area that has already been controlled, the feedback control of the current amount flowing in the current adjustment circuit may be performed using the value of the temperature sensor.

The time until the temperature of the power supply area reaches the steady state depends on the circuit area of the power supply area. Since the circuit area of the power supply area VDD (11_1) is the largest in the semiconductor device 4 shown in FIG. 13, the time (between timing t1 and timing t2) until the temperature of the power supply area VDD (11_1) reaches the steady state is the longest in the timing chart shown in FIG. 14. On the other hand, since the circuit area of the power supply area VCC (11_2) is the smallest, the time (between timing t2 and timing t3) until the temperature of the power supply area VCC (11_2) reaches the steady state is the shortest in the timing chart shown in FIG. 14.

As described above, in the semiconductor device according to this embodiment, the current amounts flowing in the current adjustment circuits 12_1 to 12_7 provided in the power supply areas 11_1 to 11_7 are controlled in order among the power supply areas 11_1 to 11_7. Therefore, it is possible to prevent the temperature of the predetermined power supply area under adjustment from being affected by the temperatures of the other power supply areas.

### Fifth Embodiment

Next, a fifth embodiment will be described. In the above-described first to fourth embodiments, the temperature of each power supply area 11_1 to 11_7 is measured using the temperature sensor incorporated in the chip, and the target temperature Tja is determined using the measurement result. In the fifth embodiment described below, the advance preparation and the burn-in test in the case where the semiconductor device does not incorporate the temperature sensor will be described. Since the semiconductor device according to this embodiment is the same as the semiconductor devices described in the first to fourth embodiments except that the semiconductor device is not provided with the temperature sensor, the description will not be repeated as appropriate.

Hereinafter, the flow of the current adjustment method in the semiconductor device according to this embodiment will be described. The following parameters are only examples, and in the current adjustment method in the semiconductor device according to this embodiment, parameters other than the following parameters may be used. Further, although the burn-in test is a test performed in the mass production stage of the semiconductor device, the following advance preparation is preferably performed, for example, in an experimental stage before the mass production stage. Since the configuration of the semiconductor device according to this embodiment is the same as the semiconductor device described in the first embodiment (see FIGS. 3, 5, 6) except that the semiconductor device is not provided with the temperature sensor, the description will not be repeated.

Preconditions for the advance preparation are defined as follows.

(1) There is no variation in current among a plurality of semiconductor devices (chips).
(2) There is no variation in currents flowing through the pairs of resistors and transistors in the same current adjustment circuit 12.
(3) The number of pairs of resistors and transistors in each current adjustment circuit 12_1 to 12_7 is 20 (i.e., each current adjustment circuit includes the resistors R1 to R20 and the transistors Tr1 to Tr20).
(4) In a state where each current adjustment circuit 12_1 to 12_7 does not perform the current adjustment, 10 transistors are turned on, and the other 10 transistors are turned off (i.e., the current flows through 10 pairs of resistors and transistors).
(5) The controlling of the current adjustment amount of each current adjustment circuit 12_1 to 12_7 by the control circuit 13 is synonymous with the controlling of the number of turned-on transistors.
(6) As for the ambient temperature Ta at the time of the burn-in test, Ta=125° C.
(7) As for the target value of a chip surface temperature at the time of the burn-in test, a current when the chip temperature reaches a steady state is measured using a current measurement device (such as a tester) for each power supply area 11_1 to 11_7, and the chip temperature Tj of each power supply area 11_1 to 11_7 is calculated using the measured current value and the following equation (1). Then, the median value of the calculated chip temperature Tj of each power supply area 11_1 to 11_7 is determined as a target temperature Tja.

Hereinafter, the equation for calculating the chip temperature Tj will be described. In this embodiment, the chip temperature Tj is a junction temperature, and is the temperature of a pn junction part. Let Ta be an ambient temperature, and θja be a thermal resistance between the chip temperature Tj and the ambient temperature Ta, the chip temperature Tj can be expressed by the following equation (1).

Tj=Ta+θja×Pd (1)

In the above equation, Pd is a value that can be obtained using Pd=(current value of predetermined power supply area)×(BI voltage of predetermined power supply area), and corresponds to a power at the time of the burn-in test in the predetermined power supply area. In the advance preparation described below, the value of the thermal resistance θja is θja=28.1° C./W as an example. The above equation (1) is formulated by reference to the following site.

https://www.renesas.com/ja-jp/support/technical-resources/package/characteristic/heat-01.html

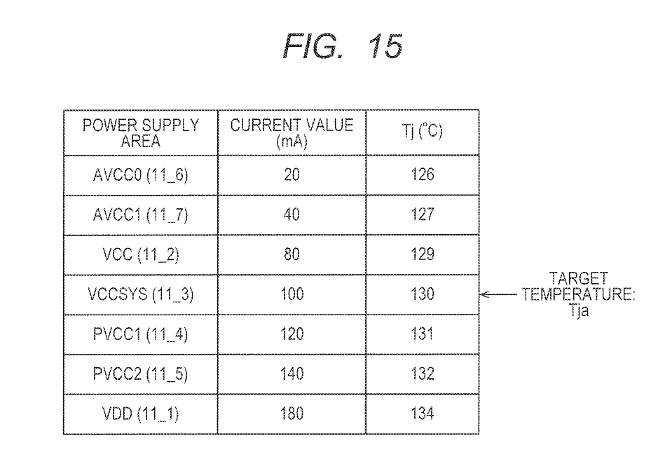

Next, the advance preparation will be described. First, one representative chip (semiconductor device) is set on the burn-in board (not shown) for the burn-in test. Then, the ambient temperature Ta in the burn-in test is set to Ta=125° C. Further, the representative chip is brought into the state where each current adjustment circuit 12_1 to 12_7 of the representative chip does not perform the current adjustment, that is, the state where 10 transistors are turned on in each current adjustment circuit 12_1 to 12_7. Then, the program for the burn-in test is executed, and the burn-in test is performed on the representative chip, thereby passing the current in each power supply area 11_1 to 11_7. At this time, the current flowing in each power supply area 11_1 to 11_7 is measured using the current measurement device (such as a tester) for each power supply area 11_1 to 11_7. Then, the chip temperature Tj of each power supply area 11_1 to 11_7 is calculated using the measured current value and the above equation (1). FIG. 15 shows the measured current value and the calculated chip temperature Tj in each power supply area 11_1 to 11_7.

As shown in FIG. 15, in the state where each current adjustment circuit 12_1 to 12_7 does not perform the current adjustment, the chip temperature Tj of each power supply area 11_1 to 11_7 varies. In this embodiment, for example, the median value of the chip temperature Tj of each power supply area 11_1 to 11_7 is determined as the target temperature Tja. More specifically, the chip temperature Tj=130° C. of the power supply area (VCCSYS) 11_3 is determined as the target temperature Tja.

Then, the current amount of each current adjustment circuit 12_1 to 12_7 is adjusted so that the chip temperature Tj of each power supply area 11_1 to 11_7 of the representative chip (semiconductor device) becomes the target temperature Tja=130° C. More specifically, the value of the register 17 in the control circuit 13 (see FIG. 6) is rewritten using an evaluation program or the like, thereby adjusting the current amount of each current adjustment circuit 12_1 to 12_7.

After the current amount of each current adjustment circuit 12_1 to 12_7 is adjusted, when each power supply area 11_1 to 11_7 of the representative chip reaches the steady state, the current value of each power supply area 11_1 to 11_7 is measured. Then, the chip temperature Tj of each power supply area 11_1 to 11_7 is calculated using the measured current value and the above equation (1). This operation is repeated until the chip temperature Tj of each power supply area 11_1 to 11_7 becomes the target temperature Tja=130° C. Then, the current adjustment amount when the chip temperature Tj of each power supply area 11_1 to 11_7 becomes the target temperature Tja=130° C., that is, the number of turned-on transistors is obtained.

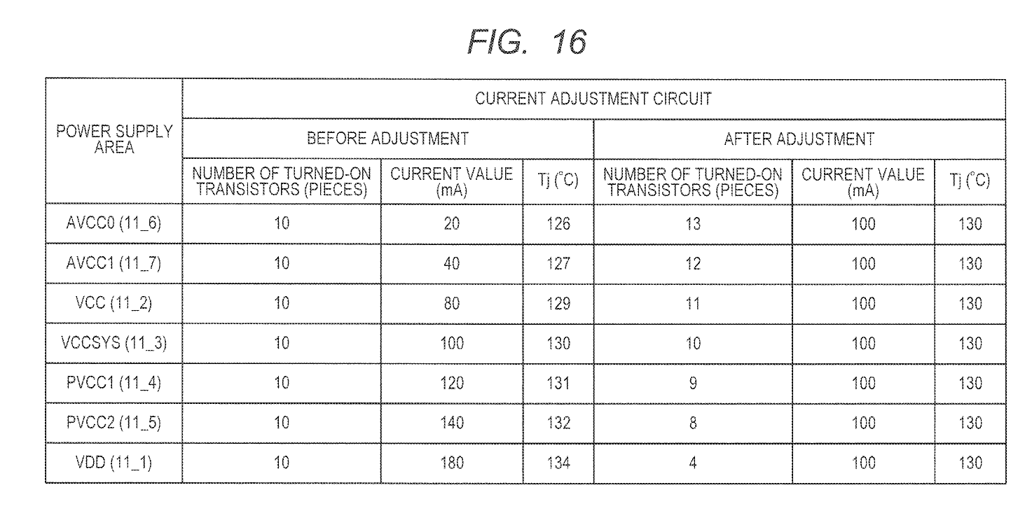

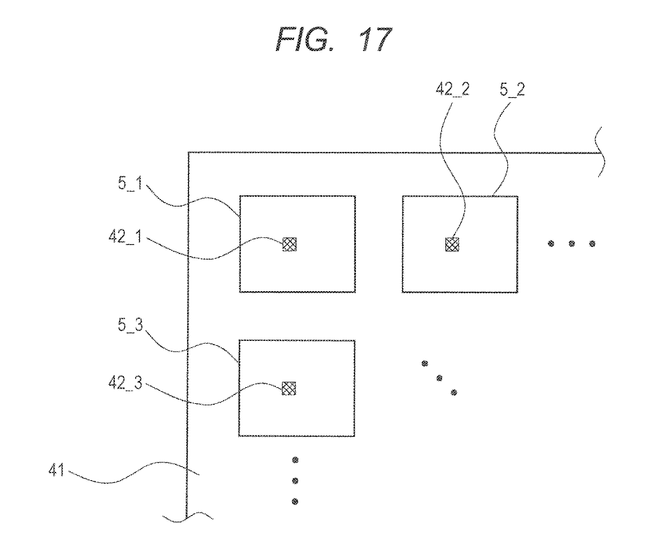

FIG. 16 is a table showing the thus-obtained current adjustment amount of each current adjustment circuit 12_1 to 12_7. For example, the calculated chip temperature Tj of the power supply area (AVCC0) 11_6 before the current adjustment is 126° C., which is lower than the target temperature Tja=130° C. Accordingly, in this case, the number of turned-on transistors is increased, thereby increasing the current amount flowing in the power supply area (AVCC0) 11_6. In the example shown in FIG. 16, 13 transistors included in the current adjustment circuit 12_6 are turned on (i.e., the number of turned-on transistors is increased by 3), thereby adjusting the calculated chip temperature Tj of the power supply area (AVCC0) 11_6 to 130° C.

Further, since the calculated chip temperature Tj of the power supply area (AVCC1) 11_7 before the current adjustment is 127° C.; in this case, 12 transistors included in the current adjustment circuit 12_7 are turned on (i.e., the number of turned-on transistors is increased by 2), thereby adjusting the calculated chip temperature Tj of the power supply area (AVCC1) 11_7 to 130° C. Further, since the calculated chip temperature Tj of the power supply area (VCC) 11_2 before the current adjustment is 129° C.; in this case, 11 transistors included in the current adjustment circuit 12_2 are turned on (i.e., the number of turned-on transistors is increased by 1), thereby adjusting the calculated chip temperature Tj of the power supply area (VCC) 11_2 to 130° C.

On the other hand, the calculated chip temperature Tj of the power supply area (PVCC1) 11_4 before the current adjustment is 131° C., which is higher than the target temperature Tja=130° C. Accordingly, in this case, the number of turned-on transistors is decreased, thereby decreasing the current amount flowing in the power supply area (PVCC1) 11_4. In the example shown in FIG. 16, 9 transistors included in the current adjustment circuit 12_4 are turned on (i.e., the number of turned-on transistors is decreased by 1), thereby adjusting the calculated chip temperature Tj of the power supply area (PVCC1) 11_4 to 130° C.

Further, since the calculated chip temperature Tj of the power supply area (PVCC2) 11_5 before the current adjustment is 132° C.; in this case, 8 transistors included in the current adjustment circuit 12_5 are turned on (i.e., the number of turned-on transistors is decreased by 2), thereby adjusting the calculated chip temperature Tj of the power supply area (PVCC2) 11_5 to 130° C. Further, since the calculated chip temperature Tj of the power supply area (VDD) 11_1 before the current adjustment is 134° C.; in this case, 4 transistors included in the current adjustment circuit 12_1 are turned on (i.e., the number of turned-on transistors is decreased by 6), thereby adjusting the calculated chip temperature Tj of the power supply area (VDD) 11_1 to 130° C.

The adjustment amount of each current adjustment circuit 12_1 to 12_7 obtained by the advance preparation, that is, the number of turned-on transistors is stored in the flash memory 14, as the adjustment amount of the current adjustment circuit 12_1 to 12_7.

Next, the burn-in test will be described. The burn-in test is a test performed in the mass production stage of the semiconductor device, and is a test performed to remove an initial failure product before shipment of the product.

After the semiconductor device is manufactured, each semiconductor device subject to the burn-in test is set on the burn-in board (not shown) for the burn-in test. Then, the ambient temperature Ta of each semiconductor device 1 is set to the predetermined temperature, and the program for the burn-in test is executed. Further, the adjustment value of the current adjustment circuit stored in the flash memory 14 of each semiconductor device is read, and the read adjustment value is written to the register 17 (see FIG. 6).

Then, when the BI mode signal is supplied from the system control circuit 15, the transistor drive circuit drives the transistors Tr1 to Tr20 of each current adjustment circuit 12_1 to 12_7 in accordance with the adjustment amount stored in the register 17. More specifically, the transistor drive circuit 18 turns on transistors whose number corresponds to the adjustment amount (i.e., the number of turned-on transistors shown in FIG. 16) stored in the register 17 among the transistors Tr1 to Tr20 of each current adjustment circuit 12_1 to 12_7.

Thereby, the current corresponding to the adjustment amount flows in each current adjustment circuit 12_1 to 12_7, so that the current amount flowing in each power supply area 11_1 to 11_7 is adjusted. In this state, the program for the burn-in test is executed. Therefore, it is possible to adjust the chip temperature Tj of each power supply area 11_1 to 11_7 at the time of the burn-in test to the target temperature Tja=130° C., and to equalize the chip temperature at the time of the burn-in test.

As described above, in the semiconductor device according to this embodiment, the current value is measured for each power supply area 11_1 to 11_7, and the chip temperature Tj of each power supply area 11_1 to 11_7 is calculated using the measured current value. Then, the target temperature Tja of each power supply area 11_1 to 11_7 is set based on each calculated chip temperature Tj, and the current amount flowing in the current adjustment circuit 12_1 to 12_7 included in the power supply area 11_1 to 11_7 is controlled in accordance with the difference between the calculated chip temperature Tj and the target temperature Tja. Therefore, even in the case where the semiconductor device does not incorporate the temperature sensor, it is possible to equalize the chip temperature at the time of the burn-in test.

Further, in this embodiment, the temperature sensor may be provided in each power supply area 11_1 to 11_7, and the feedback control of the current amount flowing in each current adjustment circuit may be performed. That is, the advance preparation described in this embodiment is performed, and the current amount flowing in each current adjustment circuit is adjusted using the adjustment amount obtained by the advance preparation. Then, the feedback control of the current amount flowing in each current adjustment circuit may be performed so that the temperature measured by the temperature sensor becomes the target temperature. In this case, although it is necessary to separately provide the temperature sensor, it is possible to perform the feedback control of the current amount flowing in each current adjustment circuit, and therefore to more accurately control the adjustment amount of each current adjustment circuit. Since the feedback control is described in the second embodiment, the description will not be repeated.

While the equalization of the respective chip temperatures of the power supply areas 11_1 to 11_7 has been described above, this embodiment is applicable to the equalization of the respective temperatures of the chips as described in the third embodiment.

When the burn-in test is performed, a plurality of semiconductor devices (chips) 5_1 to 5_n (n is an integer of 2 or more) is set on a burn-in board 41 as shown in FIG. 17. The semiconductor devices 5_1 to 5_n are provided with current adjustment circuits 42_1 to 42_n, respectively.

In this case, the current value (power supply current value) is measured for each semiconductor device 5_1 to 5_n, and the chip temperature Tj of each semiconductor device 5_1 to 5_n is calculated using the measured current value. Then, the target temperature Tja common to each semiconductor device 5_1 to 5_n is set based on each calculated chip temperature Tj, and the current amount flowing in the current adjustment circuit 42_1 to 42_n included in the semiconductor device 5_1 to 5_n is controlled in accordance with the difference between each calculated chip temperature Tj and the target temperature Tja. Thus, by controlling the current amount of the current adjustment circuit 42_1 to 42_n, it is possible to equalize the respective temperatures of the semiconductor devices 5_1 to 5_n. In this case as well, the temperature sensor may be provided in each semiconductor device 5_1 to 5_n, and the feedback control of the current amount flowing in each current adjustment circuit may be performed. That is, the advance preparation described in this embodiment is performed, and the current amount flowing in each current adjustment circuit 42_1 to 42_n is adjusted using the adjustment amount obtained by the advance preparation. Then, the feedback control of the current amount flowing in each current adjustment circuit 42_1 to 42_n may be performed so that the temperature measured by the temperature sensor becomes the target temperature. In this case, although it is necessary to separately provide the temperature sensor, it is possible to perform the feedback control of the current amount flowing in each current adjustment circuit 42_1 to 42_n, and therefore to more accurately control the adjustment amount of each current adjustment circuit 42_1 to 42_n. Since the feedback control is described in the second embodiment, the description will not be repeated.

While the invention made above by the present inventors has been described specifically based on the illustrated embodiments, the present invention is not limited thereto. It is needless to say that various changes and modifications can be made thereto without departing from the spirit and scope of the invention.

What is claimed is:

1. A semiconductor device comprising:
a current adjustment circuit capable of adjusting a current amount flowing in the current adjustment circuit itself;
a storage circuit for storing an adjustment amount of the current adjustment circuit; and
a control circuit for controlling the current amount flowing in the current adjustment circuit in accordance with the adjustment amount when a burn-in mode signal indicating a burn-in mode is supplied.

2. The semiconductor device according to claim 1,
wherein the current adjustment circuit includes a plurality of resistance elements, and
wherein the control circuit changes the number of resistance elements through which a current is passed, and thereby controls the current amount flowing in the current adjustment circuit.

3. The semiconductor device according to claim 2,
wherein the current adjustment circuit further includes a plurality set of a transistor coupled in series with the resistance element, and
wherein the control circuit changes the number of turned-on transistors, and controls the current amount flowing in the current adjustment circuit.

4. The semiconductor device according to claim 1,
wherein the semiconductor device includes a plurality of circuit blocks, and
wherein the current adjustment circuit is provided in each of the circuit blocks.

5. The semiconductor device according to claim 4,
wherein the circuit blocks are circuit blocks divided into power supply areas coupled to power supply wiring lines different from each other.

6. The semiconductor device according to claim 1, further comprising a temperature sensor for measuring a temperature of the semiconductor device,
wherein the control circuit performs feedback control of the current amount flowing in the current adjustment circuit so that the temperature measured by the temperature sensor becomes a preset target temperature.

7. The semiconductor device according to claim 6,
wherein the storage circuit stores an initial value of the adjustment amount of the current adjustment circuit and the target temperature of the semiconductor device, and
wherein the control circuit controls the current amount flowing in the current adjustment circuit in accordance with the initial value of the adjustment amount, and then performs the feedback control of the current amount flowing in the current adjustment circuit so that the temperature measured by the temperature sensor becomes the target temperature.

8. A current adjustment method in a plurality of semiconductor devices each including a current adjustment circuit capable of adjusting a current amount flowing in the current adjustment circuit itself, the current adjustment method comprising the steps of:
measuring a power supply current value for each semiconductor device;
calculating a junction temperature of each semiconductor device, using the measured power supply current value;
setting a target temperature common to the semiconductor devices based on the calculated junction temperature of each semiconductor device; and
controlling the current amount flowing in the current adjustment circuit included in each semiconductor device in accordance with each difference between each calculated junction temperature and the target temperature.

9. The current adjustment method in the semiconductor devices according to claim 8,
wherein the semiconductor device includes a temperature sensor for measuring a temperature of the semiconductor device itself, and
wherein feedback control of the current amount flowing in the current adjustment circuit is performed so that the temperature measured by the temperature sensor becomes the target temperature.

10. A current adjustment method in a semiconductor device in which a current adjustment circuit capable of adjusting a current amount flowing in the current adjustment circuit itself is provided in each circuit block, the current adjustment method comprising the steps of:
measuring a current value for each circuit block;
calculating a junction temperature for each circuit block, using the measured current value;
setting a target temperature of each circuit block based on the calculated junction temperature of each circuit block; and
controlling the current amount flowing in the current adjustment circuit included in each circuit block in accordance with each difference between the calculated junction temperature of each circuit block and the target temperature.

11. The current adjustment method in the semiconductor device according to claim 10,
wherein each circuit block includes a temperature sensor for measuring a temperature of the circuit block itself, and
wherein feedback control of the current amount flowing in the current adjustment circuit is performed so that the temperature measured by the temperature sensor becomes the target temperature.

12. The current adjustment method in the semiconductor device according to claim 11, wherein the control of the current amount flowing in the current adjustment circuit is performed in order for each circuit block.

13. The current adjustment method in the semiconductor device according to claim 10, wherein the circuit blocks are circuit blocks divided into power supply areas coupled to power supply wiring lines different from each other.
